(19) United States
(12) Patent Application Publication
(10) Pub. No.: US 2025/0322404 A1
(43) Pub. Date: Oct. 16, 2025

(54) SYSTEMS AND METHODS FOR USE IN STAND-IN NETWORK SERVICES

(71) Applicant: MASTERCARD INTERNATIONAL INCORPORATED, PURCHASE, NY (US)

(72) Inventors: Wei Xu, Millwood, NY (US); Robert Alexander Matteson, Saint Charles, MO (US)

(21) Appl. No.: 18/636,106

(22) Filed: Apr. 15, 2024

(51) Int. Cl. G06Q 20/40

(52) U.S. Cl. CPC G06Q 20/4018

(57) ABSTRACT

Systems and methods are provided for enabling stand-in network services based on truncated data. One exemplary method includes receiving an authorization request, the authorization request including an account number for an account, an expiration date associated with the account number, and a verification code specific to the account; scrambling the account number; retrieving, based on the scrambled account number, truncated data for the account from a memory; truncating the expiration date and verification code from the authorization request; comparing the truncated expiration date and the truncated verification code to the retrieved truncated data; and, in response to a match between the truncated expiration date, the truncated verification code, and the retrieved truncated data, compiling and transmitting an authorization response.

### FIELD

The present disclosure generally relates to systems and methods for use in enabling stand-in network services based on truncated data.

### BACKGROUND

This section provides background information related to the present disclosure which is not necessarily prior art.

Network interaction may be initiated for a number of different purposes. For example, network interactions are initiated as a mechanism to transfer funds, e.g., purchase transaction. As part of the purchase transaction, messaging is exchanged, which provides a basis for an issuer of an account involved in the transaction to either authorize or decline the transaction. In one or more instances, a processing network, which is involved to coordinate the transaction, may stand-in for the issuer and make a decision to either authorize or decline the transaction.

### BRIEF DESCRIPTION OF DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in performing stand-in services associated with transaction, based on truncated data;

FIG. 2 is a block diagram of a computing device that may be used in the exemplary system of FIG. 1; and

FIG. 3 is an exemplary method suitable for use with the system of FIG. 1 for performing stand-in services associated with transaction, based on truncated data.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with network interactions, such as, for example, payment transactions, associated institutions (e.g., issuers, etc.) rely on validation or verification of data included in the messaging, in order to authorize or decline the underlying transaction. For example, an issuer may verify a card-verification-code (CVC) or expiration date against a value on-file for an account, to ensure the code/date are correct. In connection with stand-in services, in which a party other than the issuer authorizes or declines the transaction, the ability to ensure the code/date is correct is limited. As it relates thereto, there is also a purpose to not store the cod/date with multiple parties, as it creates exposure in instances of breech.

Uniquely, the systems and methods herein provide for the use of truncated data, from the transaction, to verify the transaction in connection with, for example, stand-in services.

In particular, in connection with transactions, the processing network captures specific data from authorization requests, truncates the specific data and optionally treats the truncated data with a cryptographic algorithm prior to storing the truncated data and/or the encrypted output from the algorithm in association with the accounts. The truncated data includes less than the original data, such that the data, in its entirety, cannot be reconstructed from the truncated data. The encrypted output further ensures security of the original specific data associated with the authorization requests. For subsequent transactions, then, where an issuer institution is unreachable, the processing network captures the specific data from the authorization request, truncates the data in the same manner and, potentially, treats the truncated data with the same cryptographic algorithm in the same manner, and then compares the resulting value to the stored value of the treated partial data.

In this manner, the processing network, while not in possession of the specific, original data, is enabled and/or configured to verify the specific data (included in messaging associated with transactions) in connection with stand-in processing of transactions on behalf of the issuer institutions.

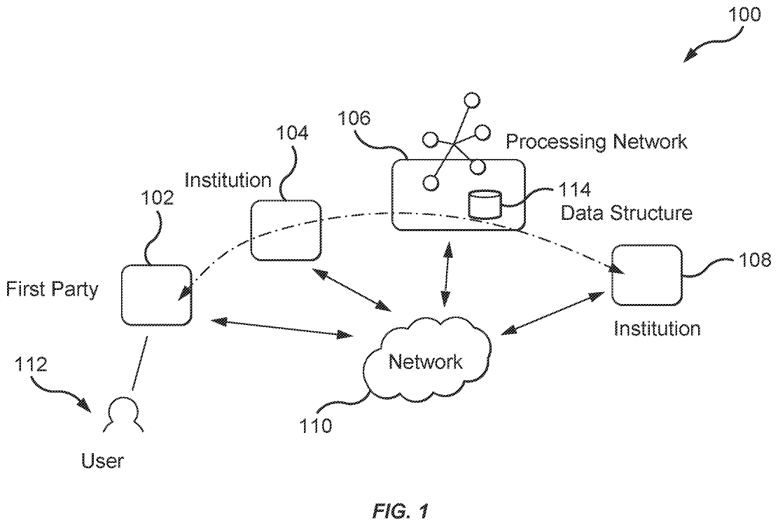

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, for example, depending on interactions between various parts in the exemplary embodiments, processing of payment transactions, privacy rules and regulations, etc.

The illustrated system 100 generally includes a first party 102, an acquirer institution 104 associated with the first party 102, a processing network 106, and an issuer institution 108 configured to issue accounts to users, each coupled to (and in communication with) network 110. The network 110 may include, without limitation, one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts of the system 100, or even combinations thereof. In one example, the network 110 includes multiple different networks, where different ones of the multiple networks are accessible to different ones of the illustrated components in FIG. 1. In particular, for example, the network 110 may include a private payment transaction network made accessible by the processing network 106 to the acquirer institution 104 and the issuer institution 108 and, separately, the public Internet, which is accessible as desired by the first party 102, the acquirer institution 104, other parts of the system 100, etc.

The first party 102 in the system 100 is configured to offer products (e.g., goods and/or services, etc.) for sale to users, including, for example, to user 112. The first party 102 may include a brick-and-mortar location having a physical presence for selling the products to the user 112. In addition (or alternatively), the first party 102 may include an online location, having a virtual presence on the Internet (e.g., one or more websites accessible through the network 110, etc.) and/or having/being associated with one or more web-based applications that permit users to initiate transactions for one or more products offered by the first party 102. Regardless, the acquirer institution 104 is associated with the first party 102, and in general, the acquirer institution 104 issues an account to the first party 102 to which funds from transactions with the first party 102 are directed.

In addition to the above, in some examples, the first party 102 may be configured to provide for fund transfer services, whereby a network-based application, website or other user-interface is hosted, sponsored, and/or offered by the first party 102 for use by the user 112. In such an example, the acquirer institution 104 may be an originator institution and, as such, in this example is the issuer for the source account for the fund transfer and the issuer institution 108 may be a receiving institution and, as such, in this example is the issuer of the receiving account into which funds are transferred and allocated to the recipient (e.g., user, merchant, first party, etc.). One example fund transfer service may include the FEDNOW instant payment service, etc.

For purchase transactions in the system 100, the issuer institution 108 may be configured to issue an account to the user 112, which may be used, by the user 112, to fund transactions with the first party 102. Alternatively, for fund transfers in the system 100, the acquirer institution, implemented as an originator institution or a funding institution (for the fund transfer) may be configured to issue an account to the user 112, which may be used, by the user 112, for performing fund transfers via the first party 102. In connection therewith, in either example, an account number (e.g., primary account number (PAN)) is issued to the user 112 and is specific to the account. In addition to the account number, the account also is associated with an expiration date card verification code (CVC). The CVC generally includes a three digit number, and the expiration date generally includes a month, date, and year. Beyond the account identifiers, the account is also associated with information specific to the user 112, including, without limitation, a name, physical address, contact information, etc. The physical address includes a street name, street number, a city, a state or territory, and a postal code (although different address forms may be used outside of the United States). The account identifiers and information specific to the user 112 are stored in memory of issuer institution 108. The present disclosure may be used to validate the user 112 in connection with such purchase transactions and fund transfers, whereby truncated data described herein may be used to approve or decline the purchase transactions, fund transfers, etc.

In general in the system 100, from time to time, the user 112 initiates a transaction for the purchase of products from the first party 102. In one exemplary transaction, the user 112 purchases a product from the first party 102, whereupon the user 112 presents to the first party 102 a payment device (e.g., a payment card, etc.) specific to the account issued by the issuer institution 108. In turn, the first party 102 is configured to capture payment account information and to communicate an authorization request for the transaction to the acquirer institution 104. The authorization request includes, among other things, an amount, an account number for the account of the user 112, the associated CVC code (e.g., in DE48 SE 92 of Authorization Request 0100 message of the ISO 8583 standard, etc.) and the expiration, a name of the user 112, an address of the user 112, a merchant ID and an acquirer ID for issuer institution 108 associated with the first party 102, a name of the first party 102, and an address of the first party 102. It should be appreciated that various other information may be included in the authorization request.

In response, the acquirer institution 104 is configured to communicate the authorization request, along the dotted path illustrated in FIG. 1, to the issuer institution 108, through the processing network 106 (e.g., through MasterCard®, VISA®, Discover®, American Express®, etc.) (or through another suitable processing service (e.g., FEDNOW instant payment service, etc.), etc.), to determine whether the payment account is in good standing and whether there is sufficient credit or funds to complete the purchase. The issuer institution 108 is configured to further verify the account number, the CVC code and the expiration date (relative to the values stored at the issuer institution 108 for the account), and potentially, the address of the user 112 (relative to the address stored at the issuer institution 108 for the account).

In response to the issuer institution 108 authorizing the transaction, the issuer institution 108 is configured to transmit an authorization response indicating the authorization back to the acquirer institution 104 and the first party 102, thereby permitting the first party 102 to continue in the transaction. The transaction is later cleared and/or settled by and between the first party 102 and the acquirer institution 104, and by and between the acquirer institution 104 and the issuer institution 108 (via appropriate agreements). In response to the issuer institution 108 declining the transaction, however, the issuer institution 108 is configured to transmit an authorization response indicating the decline back to the acquirer institution 104 and the first party 102, thereby permitting the first party 102 to stop the transaction (or seek alternate funding). The issuer institution 108 may be configured to decline the transaction for various reasons, for example, insufficient funds/credit, failed verification of the CVC code or expiration date or address, status of the account, and/or a suspicion of fraud (e.g., as defined by one or more fraud schemes employed by the issuer institution 108, etc.).

It should be appreciated that in one or more instances the issuer institution 108 may be “off-line” (unreachable with the authorization request at the time of the transaction) whereby the processing network 106 may be configured to stand in for the issuer institution 108. The issuer institution 108 may be unreachable, for example, because the issuer institution 108 is not signed-in; the transaction cannot be delivered to the issuer institution 108; the issuer institution 108 is not responding; the issuer institution 108 is under a denial of service attack; the issuer institution's authorization message fails an edit check, etc.

In connection therewith, the processing network 106 is configured to read the authorization requests from the acquirer institution 104 (and other acquirer institutions (not shown)) and the issuer institution 108. The processing network 106 is further configured to capture identifying data from the authorization request, to truncate the data, to optionally treat the truncated data with cryptographic algorithm and to store the truncated data or, as appropriate, the output of the algorithm in association with the account.

In particular, in this exemplary embodiment, the processing network 106 is configured to capture the CVC code, the expiration date, and the address of the user 112. The processing network 106 is further configured, in this exemplary embodiment, to truncate the CVC code by taking the first and last digit thereof, to truncate the expiration date by taking the last digit of the year and the last digit of the month, and to truncate the address by taking one or more digits from street number, the apartment number, and the postal code. The processing network 106 is further configured to store the truncated data in memory thereof in association with the account number of the account, or a derivative thereof (e.g., one-way hashed number, etc.).

It should be appreciated that the truncation of the specific data may includes other permutations of the data, digits, characteristics, etc., whereby certain digits or characters are omitted from the truncated data. It should further be appreciated that the cryptographic algorithm may include, for example, any suitable algorithm to obfuscate the truncated data. Example algorithm includes one-way hashing algorithms, such as, for example, the MD5, SHA-1, SHA-2, NTLM, and LANMAN algorithms, etc. It should also be appreciated that the processing network 106 may be configured to truncated certain data with cryptographic algorithm, but not other data. For example, the CVC and expiration date may be treated with the cryptographic algorithm, while the address is not.

Consequently, in response to the processing network 106 standing in for the issuer institution 108, the processing network 106 is configured to read the account number in the authorization request and to retrieve the truncated data for the account from memory thereof. The processing network 106 is further configured to truncate the CVC code, the expiration date, and the address of the user 112 in the same manner as above and to compare the newly truncated data to the truncated data retrieved from memory. Prior to the comparison, the processing network 106 may be further configured to treat the truncated CVC code, expiration data and address (or less than all of the same (e.g., treat the CVC code and expiration date, but not the address, etc.), etc.) with a cryptographic algorithm, in a consistent manner as described above.

In response to a match between the truncated data, the processing network 106 is configured to authorize the transaction, via an authorization response to the acquirer institution 104. In particular, the processing network may be configured to append a defined value to the authorization response (at DE 48 SE 87) which indicates a match between the truncated values (e.g., which may be general to all values, or specific to one of the CVC code, expiration date, address, etc.) Notably, the defined values are indicative of the matching being performed by the processing network 106 (rather than the issuer institution 108). Conversely, in response to a mismatch between the truncated data, the processing network 106 is configured to decline the transaction, via an authorization response to the acquirer institution 104. In particular, the processing network 106 may be configured to append the defined value to the authorization response (at DE 48 SE 87), which indicates that the truncated values are unmatched (e.g., which may be general to all values, or specific to one of the CVC code, expiration date, address, etc.).

While the specific data element is suggested above for the ISO 8583 standard messages, it should be appreciated that other message standards may be employed in connection with requests, responses, advisement, remittance, etc., messages, whereby the defined values may be included elsewhere in the respective messages. In one example, as it relates to a fund transfer or other applicable message type, the message standard may include the ISO 20022 message standard (whereby the matching may be performed in conjunction with the message validation, prior to transmitting of payment message, in connection with response or advice messages, as part of remittance information, or otherwise, etc.).

It should be understood that the processing network 106 may be configured to simply compile and transmit the authorization response without any additional value indicative of the above matching.

It should be appreciated that processing network 106 may be configured to also append data to an authorization response to indicate to the acquirer institution 104 that the issuer institution 108 is unreachable. For example, the processing network 106 may be configured to append a first defined value to the authorization response (at DE 48 SE 87) which indicates that the CVC code and/or expiration date is unverified. In another example, the processing network 106 may be configured to append a second defined value to the authorization response (at DE 48 SE 87) which indicates that the CVC code and/or expiration date is not processed. The acquirer institution 104, or other entity, may rely on this information in processing the transaction.

It further should be appreciated that in addition to the above, the processing network 106 may be configured to employ additional logic, rules, and/or verifications in connection with authorizing or declining transaction as a stand-in for the issuer institution 108.

While only one first party 102 and one user 112 are illustrated in FIG. 1, it should be appreciated that any number of merchants and/or consumers, as described herein, may be included in different embodiments of the system 100. Likewise, a different number of acquirer institutions and/or issuer institutions may be included. For example, different first parties may have one or more different acquirer institutions, and different users may employ payment accounts issued by one or more different issuer institutions.

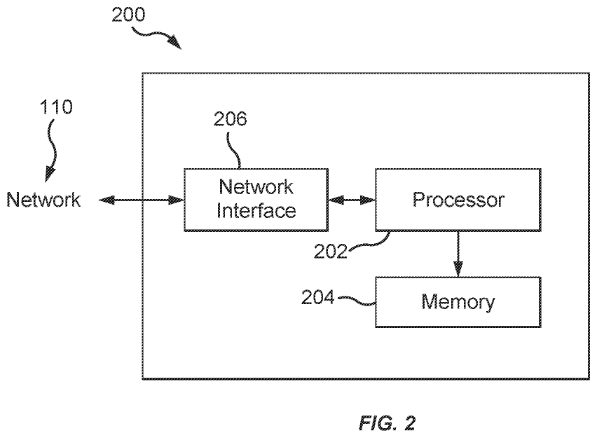

FIG. 2 illustrates an exemplary computing device 200 that can be used in the system 100. The computing device 200 may include, for example, one or more servers, workstations, personal computers, laptops, tablets, smartphones, smart devices capable of payments, such as TVs, refrigerators, vehicles (e.g., cars, trucks, boats, etc.), etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, for example, each of the first party 102, the acquirer institution 104, the processing network 106, and the issuer institution 108 are illustrated as including, or being implemented in, computing device 200, coupled to (and in communication with) the network 110. That said, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, account information, truncated data, and/or other types of data (and/or data structures) suitable for use as described herein. Furthermore, in various embodiments, executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition, the illustrated computing device 200 also includes a network interface 206 coupled to (and in communication with) the processor 202 and the memory 204. The network interface 206 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 may include the processor 202 and one or more network interfaces (including the network interface 206) incorporated into or with the processor 202.

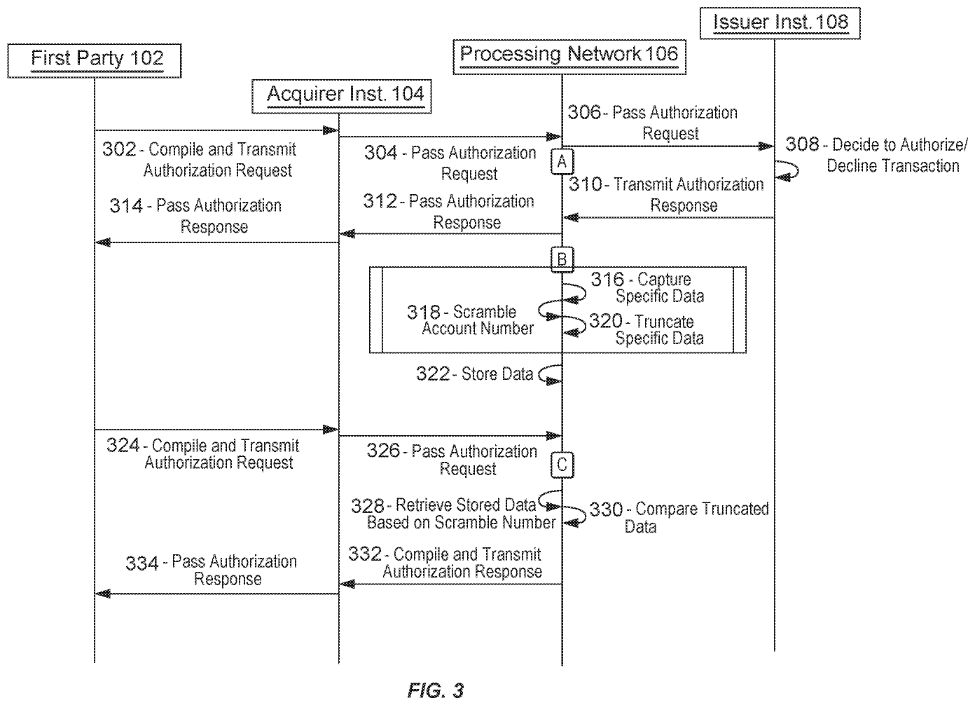

FIG. 3 illustrates exemplary method 300 that can be used in connection with the system 100 (or in connection with other systems herein) for performing stand-in services associated with transaction, based on truncated data. The exemplary method 300 is described as implemented in the system 100. However, the method 300, and other methods herein, should not be understood to be limited to the exemplary system 100, or the exemplary computing device 200. And likewise, the systems and computing devices herein should not be understood to be limited to the exemplary method 300.

At the outset, in the method 300, the processing network is configured to store truncated data for individual accounts of different users. In connection therewith, as authorization requests pass through the processing network 106 (from acquirer institutions (e.g., the acquirer institution 104) to issuer institutions (e.g., the issuer institution 108, etc.), the processing network 106 captures specific data.

As an example, as shown in FIG. 3, in response to a request from the user 112 the first party 102 compiles and transmits, at 302, an authorization to the acquirer institution 104. The authorization request contains various information related to the transaction, including, without limitation, a payment account number for the account of the user 112 (issued by the issuer institution 108), a CVC code specific to the card associated with the account (and issued by the issuer institution 108), and an expiration date of the card, and also, potentially, an address associated with user 112 who initiated the transaction (e.g., a billing address, shipping address, etc.).

The acquirer institution 104 passes, at 304, the authorization request to the processing network 106. The processing network 106 then passes, at 306, the authorization request to the issuer institution 108. The issuer institution 108 decides to authorize or decline the transaction, at 308. And, at 310, the issuer institution 108 compiles and transmits an authorization response, which indicates the authorization for the transaction, to the processing network 106. At 312, the processing network 106 passes the authorization response to the acquirer institution 104. And, the acquirer institution 104 passes the authorization response to the first party 102, at 314.

Like the authorization request, the authorization response may include the code, the expiration date, and the address. In addition, the authorization response may include one or more indications of validation of the code, the expiration date, and/or address by the issuer institution 108.

That said, the method 300 includes a sub process as illustrated, which may be employed by the processing network 106 at points A and B. As part of the sub-process, at 316, the processing network 106 captures specific data from the authorization request. In this exemplary embodiment, the specific data includes an account number (e.g., PAN, etc.), the CVC code, the expiration date, and the address. At 318, the processing network 106 scrambles the account number based on one or more techniques. For example, the processing network 106 hashes, via a one-way hash, the account number whereby the account hash is representative of the account number, but not reversible into the account number.

Next, as part of the sub-process, at 320, the processing network 106 truncates the captured data. As shown in Table 1, below, the processing network 106 truncates the data in a particular manner depending on the particular type of data. For example, for the CVC code, which is conventionally three digits, the processing network 106 truncates the data by taking 2 digits of the CVC code (e.g., the first digit and the third digit, etc.).

TABLE 1

| | Captured Data | Truncated Data |
|---|---|---|
| CVC | 123 | 13 |
| Expiration Date | 07/31 (MM/YY) | 71 |
| Address | 123 Main St., City, | 12398765 |
| | State, 98765 | |

As shown, the truncated data is not generally reconstructed into the original captured data based on the loss of information through truncation. It should be appreciated that other data from the authorization request may be captured and truncated in one or more manners. Additionally, it should be appreciated that the processing network 106 optionally (not shown) treats the truncated data with a cryptographic algorithm, to essentially, encrypt the truncated data. The cryptographic algorithm may include a one-way hash, for example, whereby the encrypted truncated data cannot be decrypted. Importantly, however, the cryptographic algorithm is repeatable, so that treating the same truncated data with the cryptographic algorithm generates the same output time after time. It should be appreciated that the treating of the data is after the data is truncated at 320, but may be after in other embodiments. In at least one embodiment, the data may be treated by the cryptographic algorithm, but not truncated.

Regardless, at 322, the truncated data (or the encrypted truncated data) is stored in memory and associated with the scrambled account number.

It should be appreciated that the processing network 106 may verify the specific data through an authorization response from the issuer institution 108, at 312, which indicates specific data has been validated by the issuer institution 108, prior to proceeding in the method 300. In such an embodiment, the processing network 106 may perform the sub-process at point B, rather than at point A, to permit reliance on the validation by the issuer institution 108 of the CVC code, the expiration date, and/or the address.

Subsequently, in FIG. 3, when the issuer institution 108 is unreachable, the processing network 106 stands in for the issuer institution 108 in order to reply to authorization requests.

In particular as shown in FIG. 3, in connection with a transaction, the first party 102 compiles and transmits an authorization request, at 324, to the acquirer institution 104. At 326, the acquirer institution 104 passes the authorization request to the processing network 106.

Because the issuer institution 108 is unreachable the processing network 106 proceeds with the sub process illustrated in FIG. 3, at point C. In particular, the processing network 106 captures specific data from the authorization request. Again, the specific data includes a payment account number for the account (issued by the issuer institution 108), a CVC code specific to a card associated with the account (and issued by the issuer institution 108), and an expiration date of the card, and also, potentially, and address associated with user who initiated transaction (e.g., a billing address, shipping address, etc.). It should be appreciated that the processing network 106 may further treat the above data, or part thereof, with a cryptographic algorithm, to the extent the truncated data from above is also treated with the cryptographic algorithm (i.e., the stored data at step 322).

At 318, the processing network 106 scrambles the account number, in a manner consistent with the description above. In addition, at 320, the processing network 106 truncates the specific data from the authorization request in a manner consistent with the description above.

With continued reference to FIG. 3, the processing network 106 retrieves, at 328, truncated data stored in memory thereof based on the scrambled account number. That is, the processing network 106 searches for truncated data based on the scrambler count. At 330, the processing network 106 compares the retrieved truncated data to the newly truncated data, from the data captured from the authorization request passed to the processing network 106, at 326.

When there is a match, the transaction is authorized and when there is no match, the transaction is declined. In either instance, at 332, the processing network 106 compiles and transmits an authorization response to the acquirer institution 104. The authorization response indicates either that the transaction is authorized or declined. In addition, the authorization response includes one or more defined values indicative of the matching of the retrieved truncated data to the newly truncated and also, potentially, the party who performed the matching (e.g., the processing network 106, etc.) (or the party that did not perform the matching (e.g., the issuer institution 108, etc.)). The defined values may be any values not already defined for another purpose.

At 334, the acquirer institution 104 passes the authorization response to the first party 102, which permits the first party 102 to either proceed with the transaction or to halt the transaction.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, by a computing device, an authorization request, the authorization request including an account number for an account, an expiration date associated with the account number, and a verification code specific to the account; (b) scrambling, by the communication device, the account number; (c) retrieving, by the computing device, based on the scrambled account number, truncated data for the account from a memory; (d) truncating, by the computing device, the expiration date and verification code from the authorization request; (e) comparing the truncated expiration date and the truncated verification code to the retrieved truncated data; and (f) in response to a match between the truncated expiration date, the truncated verification code, and the retrieved truncated data, compiling and transmitting an authorization response.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include, without limitation, a good, a service, etc.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for enabling stand-in network services based on truncated data, the computer-implemented method comprising:
receiving, by a computing device, an authorization request, the authorization request including an account number for an account, an expiration date associated with the account number, and a verification code specific to the account;
scrambling, by the computing device, the account number;
retrieving, by the computing device, based on the scrambled account number, truncated data for the account from a memory;
truncating, by the computing device, the expiration date and verification code from the authorization request;
comparing the truncated expiration date and the truncated verification code to the retrieved truncated data; and
in response to a match between the truncated expiration date, the truncated verification code, and the retrieved truncated data, compiling and transmitting an authorization response.

2. The computer-implemented method of claim 1, wherein scrambling the account number includes hashing the account number via a one-way hash.

3. The computer-implemented method of claim 1, wherein truncating the expiration date includes reserving only one digit of a month and a year of the expiration date; and
wherein truncating the verification code includes reserving only a first digit and a last digit of the verification code.

4. The computer-implemented method of claim 3, wherein the verification code includes a card verification (CVC) code having three digits.

5. The computer-implemented method of claim 3, wherein the authorization request further includes an address associated with the account; and
wherein the method includes truncating the address and comparing the truncated address to the retrieved truncated data.

6. The computer-implemented method of claim 5, wherein truncating the address includes reserving only a house number of the address and a postal code of the address.

7. The computer-implemented method of claim 1, further comprising treating the truncated expiration data and truncated verification code, with a cryptographic algorithm, prior to comparing the treated, truncated expiration date and the treated, truncated verification code to the retrieved truncated data.

8. The computer-implemented method of claim 1, further comprising:
receiving, by the computing device, a prior authorization request, the prior authorization request including the account number for the account, the expiration date associated with the account number, and the verification code specific to the account;
scrambling, by the computing device, the account number from the prior authorization request;
truncating, by the computing device, the expiration date and verification code from the prior authorization request; and
storing the truncated expiration date and the truncated verification code in the memory, in association with the scrambled account number, prior to receiving the authorization request.

9. The computer-implemented method of claim 8, further comprising treating the truncated expiration data and truncated verification code from the prior authorization request, with a cryptographic algorithm, prior to storing the treated, truncated expiration date and the treated, truncated verification code from the prior authorization.

10. The computer-implemented method of claim 1, wherein compiling the authorization response includes appending a value associated with a result of the comparison of the truncated expiration date and the truncated verification code to the retrieved truncated data.

11. A system for enabling stand-in network services based on truncated data, the system comprising:
a processing network computing device, which includes a processor and memory including executable instructions, which when executed by the processor, cause the processor to:
receive an authorization request, the authorization request including an account number for an account, an expiration date associated with the account number, and a verification code specific to the account;
scramble the account number;
retrieve, based on the scrambled account number, truncated data for the account from the memory;
truncate the expiration date and verification code from the authorization request;
compare the truncated expiration date and the truncated verification code to the retrieved truncated data; and
in response to a match between the truncated expiration date, the truncated verification code, and the retrieved truncated data, compile and transmit an authorization response.

12. The system of claim 11, wherein the executable instructions, when executed by the processor, cause the processor, in scrambling the account number, to hash the account number via a one-way hash.

13. The system of claim 11, wherein the executable instructions, when executed by the processor, cause the processor, in truncating the expiration date, to reserve only one digit of a month and a year of the expiration date; and
wherein the executable instructions, when executed by the processor, cause the processor, in truncating the verification code, to reserve only a first digit and a last digit of the verification code.

14. The system of claim 13, wherein the verification code includes a card verification (CVC) code having three digits.

15. The system of claim 13, wherein the authorization request further includes an address associated with the account; and
wherein the executable instructions, when executed by the processor, cause the processor, to:
truncate the address; and
compare the truncated address to the retrieved truncated data.

16. The system of claim 15, wherein the executable instructions, when executed by the processor, cause the processor, in truncating the address, to reserve only a house number of the address and a postal code of the address.

17. The system of claim 11, wherein the executable instructions, when executed by the processor, further cause the processor to: treat the truncated expiration data and verification code, with a cryptographic algorithm, prior to comparing the treated, truncated expiration date and the treated, truncated verification code to the retrieved truncated data.

18. The system of claim 11, wherein the executable instructions, when executed by the processor, further cause the processor to:
receive a prior authorization request, the prior authorization request including the account number for the account, the expiration date associated with the account number, and the verification code specific to the account;
scramble, the account number from the prior authorization request;
truncate the expiration date and verification code from the prior authorization request; and
store the truncated expiration date and the truncated verification code in the memory, in association with the scrambled account number, prior to receiving the authorization request.

19. The system of claim 18, wherein the executable instructions, when executed by the processor, further cause the processor to: treat the truncated expiration data and truncated verification code from the prior authorization request, with a cryptographic algorithm, prior to storing the treated, truncated expiration date and the treated, truncated verification code from the prior authorization.

20. The system of claim 11, wherein the executable instructions, when executed by the processor, cause the processor, in compiling the authorization response, to append a defined value associated with a result of the comparison of the truncated expiration date and the truncated verification code to the retrieved truncated data.
